(19) United States
(12) Patent Application Publication
(10) Pub. No.: US 2024/0280884 A1
(43) Pub. Date: Aug. 22, 2024

(54) PHOTOGRAPHY SUPPORT DEVICE, PHOTOGRAPHY SUPPORT METHOD, AND PROGRAM

(71) Applicant: NIPPON TELEGRAPH AND TELEPHONE CORPORATION, Tokyo (JP)

(72) Inventors: Tetsuro YAMAZAKI, Tokyo (JP); Hiroshi CHIGIRA, Tokyo (JP); Masafumi SUZUKI, Tokyo (JP); Hideaki IWAMOTO, Tokyo (JP); Tatsuya MATSUI, Tokyo (JP); Satoshi SAKUMA, Tokyo (JP)

(73) Assignee: NIPPON TELEGRAPH AND TELEPHONE CORPORATION, Tokyo (JP)

(21) Appl. No.: 18/567,742

(22) PCT Filed: Jun. 10, 2021
(86) PCT No.: PCT/JP2021/022207

§ 371 Date: Dec. 6, 2023

(51) Int. Cl. G03B 17/53; G03B 15/00; G03B 17/56; H04N 23/63

(52) U.S. Cl. CPC G03B 17/53; G03B 15/00; G03B 17/561; H04N 23/633

(57) ABSTRACT

An imaging support device (1) according to the present invention includes: a countdown signal generation unit (11) that generates a countdown signal indicating a countdown number decremented at regular time intervals from a setting value, and an imaging control unit (13) that transmits imaging execution signals multiple times to an imaging device (15) until the countdown number becomes “0”.

### TECHNICAL FIELD

The present disclosure relates to an imaging support device, an imaging support method, and a program.

### BACKGROUND ART

Conventionally, when a photographer takes a picture together with a family member, a friend, and the like, a countdown is displayed to cause a subject to take a pose at the same timing, and a photo shoot is performed while holding the pose.

Non Patent Literature 1 describes a method of using an installation type ID photo machine that performs a photo shoot of various certificates. In order to make the impression of the subject in the picture better, before imaging, the subject is forced to adjust the face direction by matching the eyes to the camera installed at the front, and hold the state in which the appearance, expression, and the like are adjusted for a certain period of time while looking at the image of the subject face displayed on the front glass monitor.

### CITATION LIST

### Non Patent Literature

Non Patent Literature 1: “ID photo Ki-Re-i”, [online], [searched on May 21, 2021], Internet <URL:https://www.dnpphoto.jp/corp-customer/kirei/>

### SUMMARY OF INVENTION

### Technical Problem

As illustrated in FIG. 4, a conventional imaging support device 10 that supports a photo shoot performs the following operation. A countdown signal generation unit 11 generates a countdown signal a and outputs the countdown signal a to a display control unit 12. The display control unit 12 outputs, to a display device 14, the number decremented at regular time intervals (for example, “5”→“4”→“3”→“2”→“1”→“0”), which is the content of the received countdown signal a, as display information b. When the display device 14 starts displaying the contents of the countdown signal a, the subject S takes a determined pose. When the countdown ends (the number becomes “0”), the countdown signal generation unit 11 outputs an imaging execution signal c to an imaging device 15. Upon receiving the imaging execution signal c, the imaging device 15 shoots an image of the subject S.

However, the conventional imaging support device 10 often causes the problem that the pose of the subject fails before the countdown ends, and an image of the determined pose is not shot at the timing when the countdown ends.

An object of the present invention made in view of such circumstances is to alleviate the problem that the pose of the subject fails before the countdown ends, and the image of the determined pose is not shot at a timing when the countdown ends.

### Solution to Problem

In order to solve the above problem, an imaging support device according to an embodiment is an imaging support device that supports a photo shoot, and includes a countdown signal generation unit that generates a countdown signal indicating a countdown number decremented at regular time intervals from a setting value, and an imaging control unit that transmits imaging execution signals multiple times to an imaging device until the countdown number becomes “0”.

In order to solve the above problem, an imaging support method according to an embodiment is an imaging support method in an imaging support device that supports a photo shoot, the imaging support method including, by the imaging support device, generating a countdown signal indicating a countdown number decremented at regular time intervals from a setting value, and transmitting imaging execution signals multiple times to an imaging device until the countdown number becomes “0”.

In order to solve the above problems, a program according to the embodiment causes a computer to function as the above imaging support device.

### Advantageous Effects of Invention

According to the present invention, even if the pose of the subject fails before the countdown ends, the image of the determined pose can be acquired by capturing the pose taken before the pose of the subject fails.

### BRIEF DESCRIPTION OF DRAWINGS

FIG. 1 is a block diagram illustrating a configuration example of an imaging support device according to an embodiment.

FIG. 2 is a flowchart illustrating an example of an imaging support method executed by the imaging support device according to the embodiment.

FIG. 3 is a block diagram of a schematic configuration of a computer that functions as the imaging support device.

FIG. 4 is a block diagram illustrating a configuration example of a conventional imaging support device.

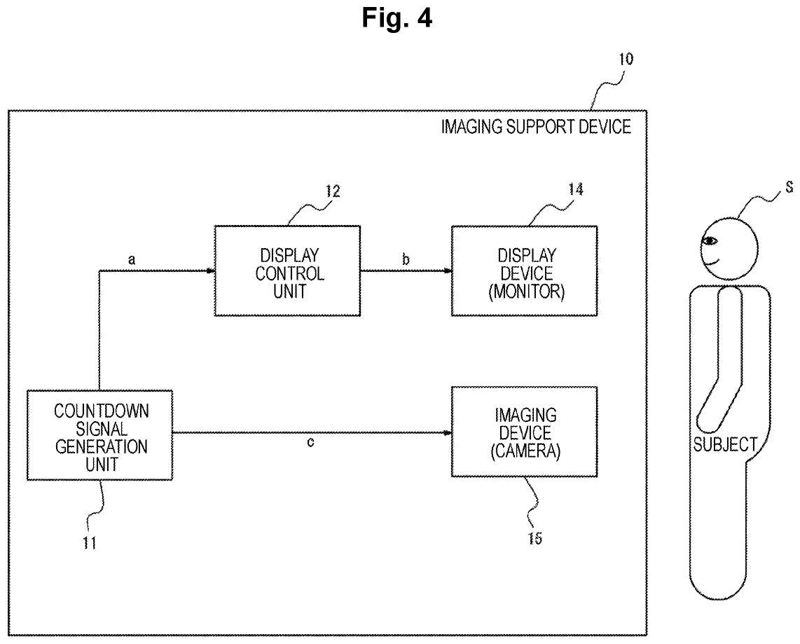

### DESCRIPTION OF EMBODIMENTS

Hereinafter, an imaging support device according to an embodiment will be described in detail. The present invention is not limited to the embodiment described below, and various modifications can be made within the scope of the gist of the present invention.

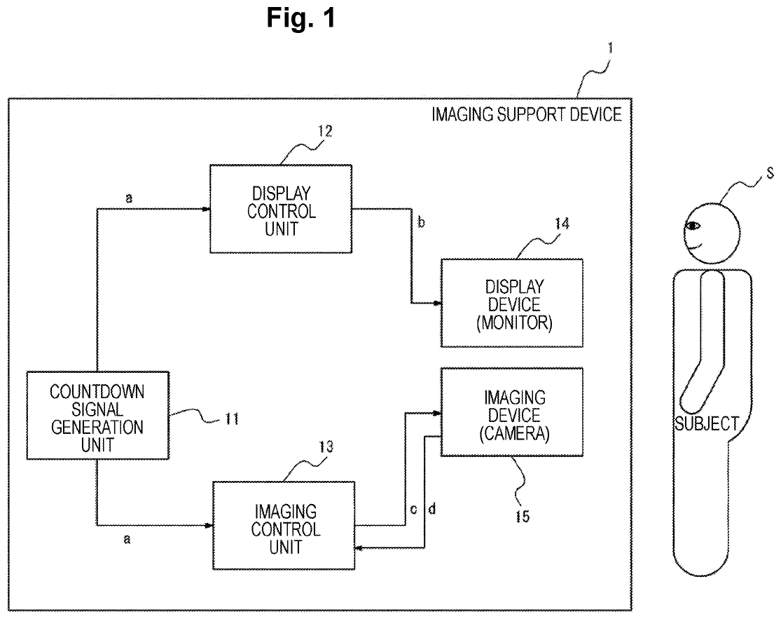

As illustrated in FIG. 1, an imaging support device 1 according to the embodiment includes a countdown signal generation unit 11, a display control unit 12, and an imaging control unit 13. The imaging support device 1 supports imaging of a subject S.

The countdown signal generation unit 11 generates a signal (countdown signal a) indicating a countdown number decremented at regular time intervals from a setting value set by a user (subject S), and outputs the signal to the display control unit 12 and the imaging control unit 13. For example, in a case where “5” is set as the setting value, the countdown signal generation unit 11 generates and outputs a countdown signal a indicating countdown numbers “4”, “3”, “2”, and “1” decreased by one every second. When the countdown number becomes “0” after five seconds, the output of the countdown signal a is stopped. The user can set any value of two or more as the setting value.

The display control unit 12 receives the countdown signal from the countdown signal generation unit 11 and generates countdown notification information b indicating the content (for example, “5” and “0”) of the countdown signal. The display control unit 12 outputs the countdown notification information b to the display device 14 in a case where the countdown notification information b is an image, and outputs the countdown notification information b to a speaker (not illustrated) in a case where the countdown notification information b is a voice.

The display device 14 receives the countdown notification information b from the display control unit 12 and displays a countdown number. When the subject S visually recognizes the start of display of the countdown number, the subject S takes the determined pose.

The imaging control unit 13 inputs the countdown signal a from the countdown signal generation unit 11. When the countdown signal a is input, the imaging control unit 13 transmits an imaging execution signal c multiple times to the imaging device 15 until the countdown number indicated by the countdown signal a becomes “0”. The imaging control unit 13 may output the imaging execution signal c to the imaging device 15 after waiting for the countdown number to become equal to or less than a threshold. The interval of the imaging execution signal c may not be equal. For example, the imaging control unit 13 may increase the number of times of outputting the imaging execution signal c to the imaging device 15 (narrow the interval of outputting the imaging execution signal c) as the countdown number indicated by the countdown signal a approaches “0”.

After receiving the countdown signal a, the imaging control unit 13 may start inputting video information d shot by the imaging device (camera) 15 and analyze the acquired video information d. For example, in order to execute the photo shoot at the timing with small movement blurring, the imaging control unit 13 may determine that the image blurring tends to decrease when the low frequency component of the acquired video information tends to decrease, and output the imaging execution signal c to the imaging device 15 multiple times after the low frequency component of the video becomes equal to or less than the threshold. Furthermore, for example, in order to avoid shooting with the eyes closed, the imaging control unit 13 may determine that the eyes are open for several seconds after closing the eyes, and output the imaging execution signal c to the imaging device 15 multiple times after detecting the state where the eyes are closed.

The imaging device (camera) 15 executes a photo shoot of the subject S every time the imaging execution signal c is received from the imaging control unit 13. That is, the imaging device 15 executes the shooting even during the countdown.

Comparing the imaging support device 1 according to the embodiment with the conventional imaging support device 10, the difference is that the imaging support device 1 includes the imaging control unit 13. In the imaging support device 10, the countdown signal generation unit 11 outputs the one-time imaging execution signal c to the imaging device 15 at the time when the countdown ends. On the other hand, in the imaging support device 1, even during the countdown, the imaging control unit 13 outputs the imaging execution signal c multiple times to the imaging device 15 every time the countdown signal a is received until the countdown signal “0” is received. Therefore, with the imaging support device 1 in the embodiment, even if the pose of the subject S fails before the countdown ends, the image of the determined pose can be acquired since the pose taken before the pose of the subject S fails is shot.

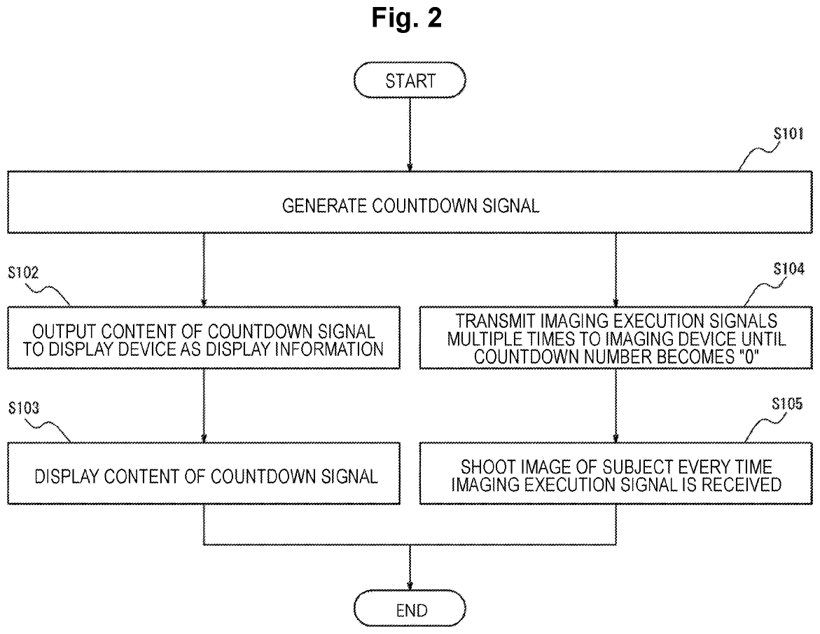

FIG. 2 is a flowchart illustrating an example of an imaging support method executed by the imaging support device 1 according to the embodiment.

In step S101, the countdown signal generation unit 11 generates the countdown signal a indicating the countdown number decremented at regular time intervals from the set countdown number, and outputs the countdown signal a to the display control unit 12 and the imaging control unit 13.

In step S102, the display control unit 12 outputs the content of the countdown signal to the display device 14 as display information b.

In step S103, a monitor 14 displays the content of the countdown signal a.

In step S104, when the first countdown signal a is input, the imaging control unit 13 transmits the imaging execution signal c multiple times to the imaging device 15 until the countdown number becomes “0”.

In step S105, the imaging device 15 shoots the image of the subject S every time the imaging execution signal c is received from the imaging control unit 13.

As described above, the imaging support device 1 outputs the imaging execution signal c multiple times to the imaging device 15 until the countdown number becomes “0” after receiving the countdown signal. Thus, with the imaging support device 1, it is possible to shoot an image of the subject S even during the countdown. Therefore, even when the pose of the subject S fails during the countdown, it is possible to acquire the image before the pose fails.

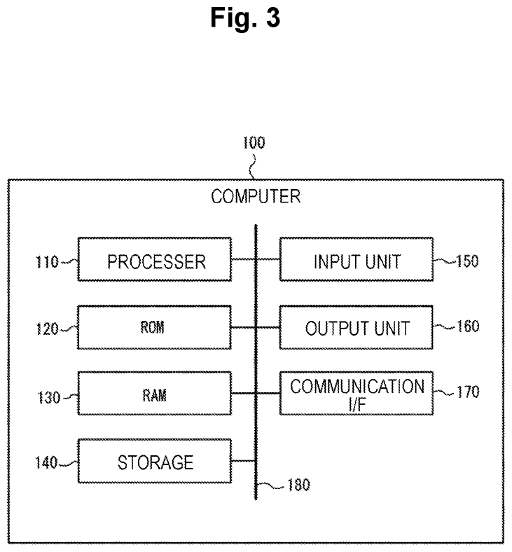

In order to function as the imaging support device 1 described above, it is also possible to use a computer capable of executing a program instruction. FIG. 3 is a block diagram of a schematic configuration of a computer that functions as the imaging support device 1. Here, a computer 100 may be a general-purpose computer, a dedicated computer, a workstation, a personal computer (PC), an electronic note pad, or the like. The program instruction may be a program code, code segment, or the like for executing a necessary task.

As illustrated in FIG. 3, the computer 100 includes a processor 110, a read only memory (ROM) 120, a random access memory (RAM) 130, and a storage 140 as a storage unit, an input unit 150, an output unit 160, and a communication interface (I/F) 170. The components are communicably connected to each other via a bus 180. The imaging device 15 in the imaging support device 1 may be constructed as the input unit 150.

The ROM 120 stores various programs and various kinds of data. The RAM 130 temporarily stores a program or data as a work area. The storage 140 includes a hard disk drive (HDD) or a solid state drive (SSD) and stores various programs including an operating system and various kinds of data. In the present disclosure, the program according to the present disclosure is stored in the ROM 120 or the storage 140.

Specifically, the processor 110 is a central processing unit (CPU), a micro processing unit (MPU), a graphics processing unit (GPU), a digital signal processor (DSP), a system on a chip (SoC), or the like and may be configured by a plurality of the same or different kinds of processors. The processor 110 reads the program from the ROM 120 or the storage 140 and executes the program by using the RAM 130 as a work area, thereby controlling each of the above components and performing various kinds of arithmetic processing. At least some of those processing contents may be implemented by hardware.

The program may be recorded in a recording medium that can be read by the computer 100. When such a recording medium is used, the program can be installed in the computer 100. Here, the recording medium on which the program is recorded may be a non-transitory recording medium. The non-transitory recording medium is not particularly limited, but may be, for example, a CD-ROM, a DVD-ROM, a universal serial bus (USB) memory, or the like. The program may be downloaded from an external device via a network.

Regarding the above embodiment, the following supplementary notes are further disclosed.

(Supplementary Note 1)

An imaging support device that supports a photo shoot, the imaging support device generating a countdown signal indicating a countdown number decremented at regular time intervals from a setting value, and including a control unit that transmits imaging execution signals multiple times to an imaging device until the countdown number becomes “0”.

(Supplementary Note 2)

The imaging support device according to Supplementary Note 1 in which
the imaging device executes a photo shoot every time the imaging execution signal is received.

(Supplementary Note 3)

The imaging support device according to Supplementary Note 1 or 2 in which
the control unit starts input of video information shot by the imaging device after receiving the countdown signal, and analyzes the acquired video information.

(Supplementary Note 4)

An imaging support method in an imaging support device that supports a photo shoot, the imaging support method including:
by the imaging support device,
generating a countdown signal indicating a countdown number decremented at regular time intervals from a setting value; and
transmitting imaging execution signals multiple times to an imaging device until the countdown number becomes “0”.

(Supplementary Note 5)

A non-transitory storage medium that stores a program capable of being executed by a computer, the program causing the computer to function as the imaging support device according to any one of Supplementary Notes 1 to 3.

The above-described embodiment has been described as a representative example, and it is apparent to those skilled in the art that many modifications and substitutions can be made within the spirit and scope of the present disclosure. Therefore, it should not be understood that the present invention is limited by the above-described embodiment, and various modifications or changes can be made without departing from the scope of the claims. For example, a plurality of configuration blocks illustrated in the configuration diagrams of the embodiment can be combined into one, or one configuration block can be divided.

### REFERENCE SIGNS LIST

1 Imaging support device
11 Countdown signal generation unit
12 Display control unit
13 Imaging control unit
14 Display device (monitor)
15 Imaging device (camera)
100 Computer
110 Processor
120 ROM
130 RAM
140 Storage
150 Input unit
160 Output unit
170 Communication interface (I/F)
180 Bus

1. An imaging support device that supports a photo shoot, the imaging support device comprising a processor configured to execute operations comprising:
generating a countdown signal indicating a countdown number decremented at regular time intervals from a setting value; and
transmitting, based on the countdown number, imaging execution signals multiple times to an imaging device.

2. The imaging support device according to claim 1, wherein the imaging device executes a photo shoot when an imaging execution signal is received.

3. The imaging support device according to claim 1, wherein the transmitting further comprises:
starting input of video information shot by the imaging device after receiving the countdown signal, and analyzing the acquired video information.

4. An imaging support method in an imaging support device that supports a photo shoot, the imaging support method comprising:
generating a countdown signal indicating a countdown number decremented at regular time intervals from a setting value; and
transmitting, based on the countdown number, imaging execution signals multiple times to an imaging device.

5. A computer-readable non-transitory recording medium storing a computer-executable program instructions that when executed by a processor cause a computer system to execute operations comprising:
generating a countdown signal indicating a countdown number decremented at regular time intervals from a setting value; and
transmitting, based on the countdown number, imaging execution signals multiple times to an imaging device.

6. The imaging support device according to claim 1, wherein the transmitting further comprises transmitting a plurality of the imaging execution signals to the imaging device until the countdown number becomes a predetermined value.

7. The imaging support device according to claim 1, wherein the imaging execution signals include capturing an image of a subject.

8. The imaging support device according to claim 1, the processor further configured to execute operations comprising:
capturing video data of a subject; and
determining a low frequency component of the captured video data, wherein the transmitting further comprises transmitting, based on the low frequency component of the captured video data, at least one imaging execution signal to the imaging device.

9. The imaging support device according to claim 1, wherein the transmitting further comprises transmitting, based on detecting a closure of an eye of a subject, at least one imaging executing signal to the imaging device.

10. The imaging support device according to claim 1, further comprising:
displaying the countdown number.

11. The imaging support method according to claim 4, wherein the imaging device executes a photo shoot when an imaging execution signal is received.

12. The imaging support method according to claim 4, wherein the transmitting further comprises:
starting input of video information shot by the imaging device after receiving the countdown signal, and
analyzing the acquired video information.

13. The imaging support method according to claim 4, wherein the transmitting further comprises transmitting a plurality of the imaging execution signals to the imaging device until the countdown number becomes a predetermined value.

14. The imaging support method according to claim 4, wherein the imaging execution signals include capturing an image of a subject.

15. The imaging support method according to claim 4, further comprising:
capturing video data of a subject; and
determining a low frequency component of the captured video data, wherein the transmitting further comprises transmitting, based on the low frequency component of the captured video data, at least one imaging execution signal to the imaging device.

16. The imaging support method according to claim 4, wherein the transmitting further comprises transmitting, based on detecting a closure of an eye of a subject, at least one imaging executing signal to the imaging device.

17. The imaging support method according to claim 4, wherein the imaging device executes a photo shoot when an imaging execution signal is received.

18. The computer-readable non-transitory recording medium according to claim 5, wherein the imaging device executes a photo shoot when an imaging execution signal is received, and the transmitting further comprises:
starting input of video information shot by the imaging device after receiving the countdown signal, and
analyzing the acquired video information.

19. The computer-readable non-transitory recording medium according to claim 5, wherein the transmitting further comprises transmitting, based on detecting a closure of an eye of a subject, at least one imaging executing signal to the imaging device.

20. The computer-readable non-transitory recording medium according to claim 5, the computer-executable program instructions when executed further causing the computer system to execute operations comprising:
capturing video data of a subject; and
determining a low frequency component of the captured video data, wherein the transmitting further comprises transmitting, based on the low frequency component of the captured video data, at least one imaging execution signal to the imaging device.
